(19) United States
(12) Patent Application Publication
(10) Pub. No.: US 2009/0302808 A1
(43) Pub. Date: Dec. 10, 2009

(54) Flywheel electricity generator

(75) Inventor: Viral Nandkumar Patel, Statesboro, GA (US)

Correspondence Address: Viral .N. Patel, 620 Fair Rd. #4, Statesboro, GA, 30458, US

(73) Assignee: VIRAL NANDKUMAR PATEL, STATESBORO, GA (US)

(21) Appl. No.: 12/156,843

(22) Filed: Jun. 5, 2008

(51) Int. Cl. H02K 7/02

(52) U.S. Cl. 322/4; 310/153

(57) ABSTRACT

A flywheel (magnet rotors or stators) assembly to create electricity, by attaching motor to provide kinetic energy to magnet rotors or stators, so magnet rotors or stators can run on principal of flywheel to create electricity by magnet rotors rotating like flywheel on two sides of stator, and stator rotating like flywheel in-between magnet rotors.

### BACKGROUND OF THE INVENTION

1. Field of the Invention

The invention presented here is related to the generation of electricity. It will be a portable and self-powered and force driven flywheel electricity generation system. This system will be composed of wheel or gear, which powered by low power motor. This wheel or gear is connected to magnet rotors or stator, which acts like flywheel and it, will create energy by running on science's rule of flywheel.

2. Description of Prior Art

The price of crude oil going over $125 a barrel and other fuels, such as coal, which causes global climate changes makes the current method unbefitting for the environment and human. Nuclear power generators are always a threat to the nation, and other sources like wind power, water damn, solar and thermal, are not available nation wide and they are also expensive.

In this invention concept of flywheel is use. A flywheel is a rotating disc used as a storage device for kinetic energy. Flywheel is use in many places as energy storage device on the place of battery. In this invention flywheel is a magnet rotor or stator that store's kinetic energy. In this invention magnet rotor and stator has shape like disc and all the characteristics that flywheel has and needs. Flywheel (magnet rotors or stator) is use to create energy by rotating magnet rotors around stator or stator in-between magnet rotors. This invention use one or more then one set of turbine (two magnet rotors and one stator).

The concept of flywheel (magnet rotors or stator) power generator is the same as that of wind power turbine generator. The difference between the two is that wind power turbine generator uses only one turbine (two magnet rotors and one stator) and it is fuel by wind. Wind is always doesn't flow at same speed all the time, so turbine cannot work that good that it needed too work. On the other hand this invention use one or more then one set of turbine, it is running on principals of flywheel so it need very low energy to keep running, it is more constant, low cost and low maintenance then wind power turbine generator.

The present invention is to provide a new way of generating power using flywheel (magnet rotors or stator). This invention can change the way the world looks at the energy production. Its invention is much better than that of wind power generators, and it is also environmentally friendly and inexpensive, when compared to nuclear generator and others.

The present invention provides a clean and inexpensive way to produce electricity anywhere energy is needed.

### SUMMARY OF THE INVENTION

An object of the present invention is to provide portable or permanent completely self-sufficient system for generation electricity applying concept of flywheel on magnet rotors or stator.

In brief, rotating magnet rotors around stator or stator rotating in-between magnet rotors becomes flywheel by storing kinetic energy and creates electricity. To maintain speed and kinetic energy of flywheel (magnet rotors or stator) to produce needed amount of electricity, flywheels (magnet rotors or stators) needs to be connected with motor by any suitable means such as a belt, wheel, gear, or transmission gearing to transmit kinetic energy to flywheel (magnet rotors or stators).

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is an elevation view of the flywheels (magnet rotors) and stators assembly of the present invention, and showing the external support wheel to support and start wheel for flywheels (magnet rotors or stators) assembly:

FIG. 2 is a perspective view showing the flywheels (magnet rotors) and stators assembly:

FIG. 3 is an elevation view of the flywheels (stators) and stators assembly of the present invention, and showing the external support wheel to support and start wheel for flywheels (magnet rotors or stators) assembly:

FIG. 4 is a perspective view showing the flywheels (stators) and magnet rotors assembly:

FIG. 5 is a perspective view showing built-in support and start wheel for flywheels (magnet rotors or stators) assembly:

FIG. 6 is a perspective view showing built-in support and start wheel for flywheels (magnet rotors or stators) assembly:

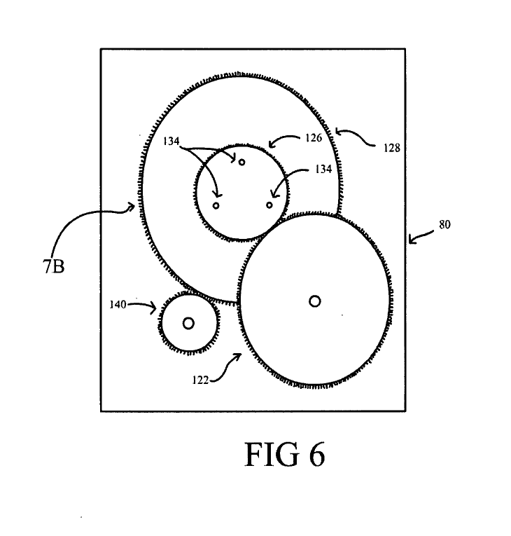

FIG. 7 is an elevation view in partial section of the flywheels (magnet rotors) and stators assembly of the present invention, and showing the built-in support wheel to support and start wheel for flywheels (magnet rotors and stators) assembly:

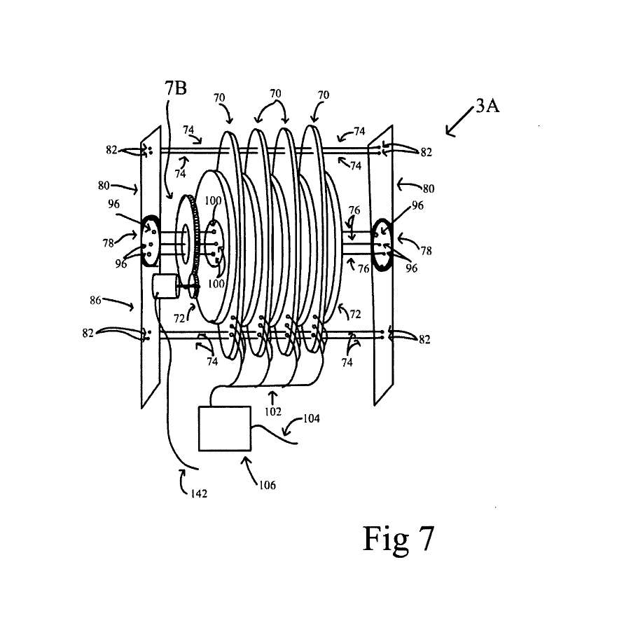

### DETAILED DESCRIPTION OF THE INVENTION

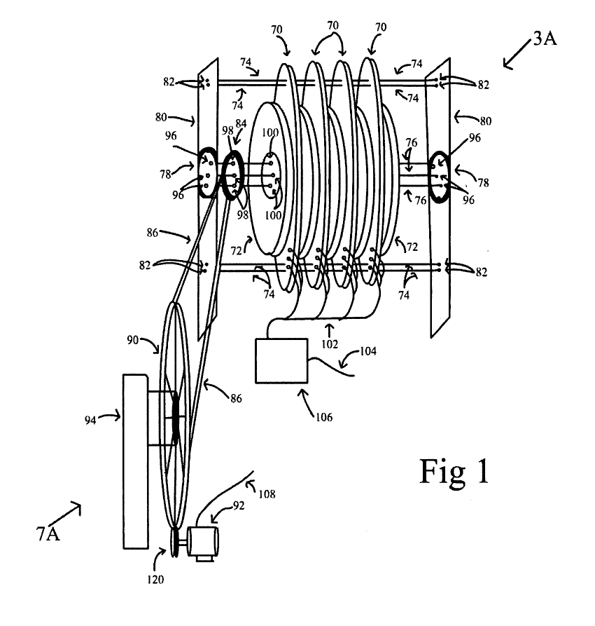

In FIGS. 1 thru 7, each of them is a perspective view showing the structure of the flywheels (magnet rotors or stators) electricity generator of the present invention. As showing in the figures, the flywheels (magnet rotors 72 or stators 70) generator of the present invention comprises flywheels (magnet rotors 72) assembly 3A, flywheels (stators 72) assembly 3B, external start and support wheel or gear assembly 7A and built-in start and support wheel or gear assembly 7B.

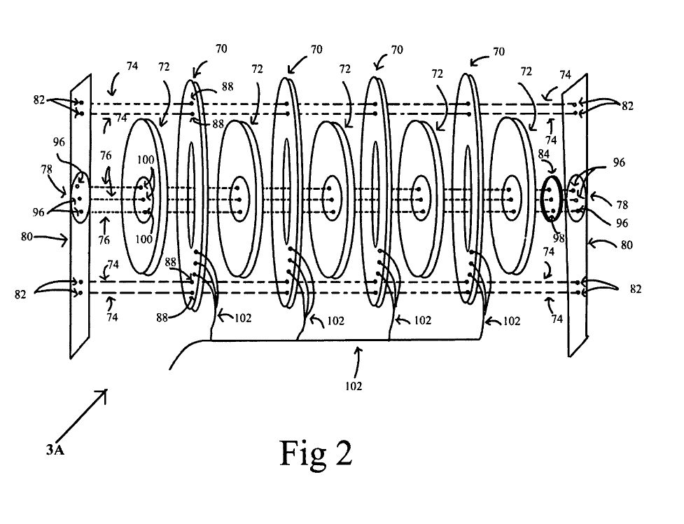

In FIGS. 1 and 2 flywheels (magnet rotors 72) assembly 3A has two supports 80 to keep flywheels assembly 3A in a vertical orientation on a horizontal position with low friction bearings 78 so flywheels can rotate without losing too much of it's kinetic energy.

To generate electricity by rotating magnet rotors 72 using flywheel concept in assembly 3A, magnet rotors 72 must be connected to low friction bearings 78 using rods 76. Rods 76 must be secured by using bolts 100 at magnet rotors 72, at bearings 78 using bolts 96, and at flywheels drive wheel or gear 84 using bolts 98. The stators 70 must be connected with supports 80 using rods 74. Rods 74 must be secured by using bolts 82 with supports 80 and at stators 70 by using bolts 88. The stators 70 must be counted with electric wiring 102 so it can transfer electricity away from stators 70 to transformer 106.

In FIG. 1 flywheel (magnet rotors 72) can start and supported by assembly 7A or 7B or both.

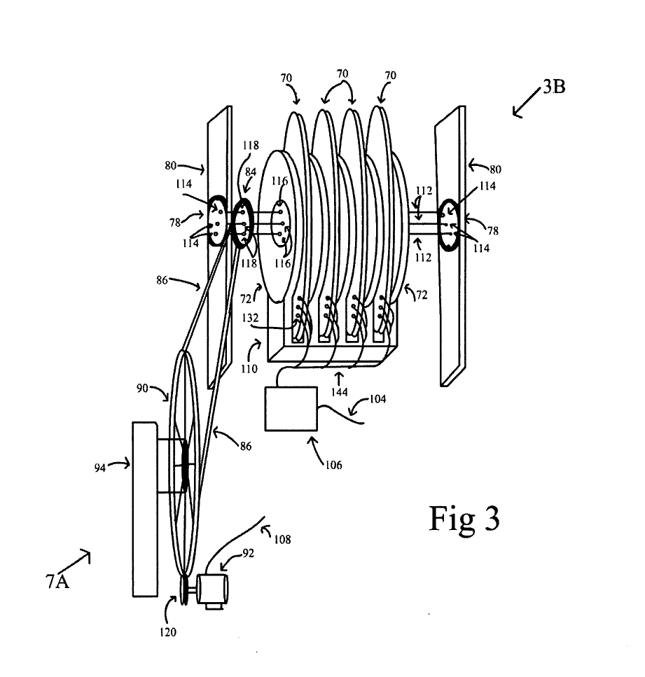

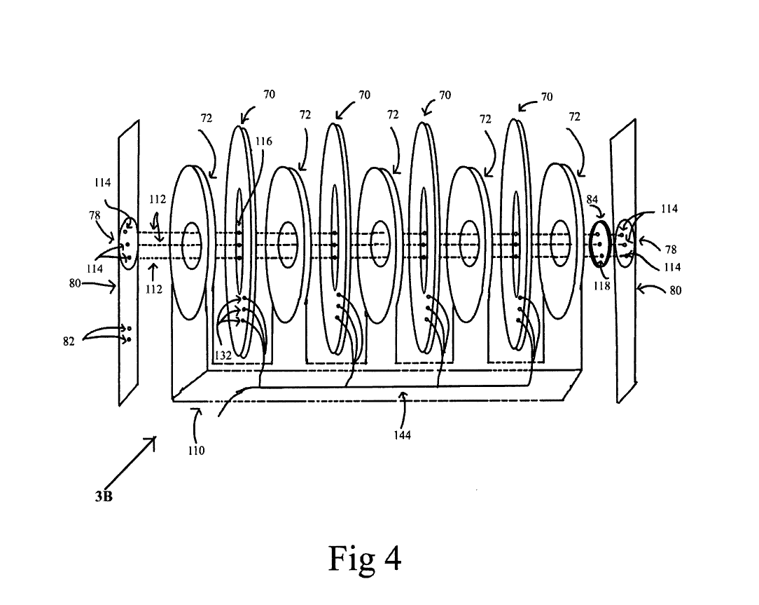

In FIGS. 3 and 4 flywheels (stators 70) assembly 3B has two supports 80 to keep flywheels assembly 3B in a vertical orientation on a horizontal position with low friction bearings 78 so flywheels can rotate without losing too much of it's kinetic energy.

To generate electricity by rotating stators 70 using flywheel concept in assembly 3B, stators 70 must be connected to low friction bearings 78 using rods 112. Rods 112 must be secured by at stators 70 by using bolts 116, at bearings 78 by using bolts 114, and flywheels drive wheel 84 using bolts 118. The magnet rotors 72 must be jointed together to magnet rotors stand 110. The stators 70 must be counted with electric brushes 132. Brushes 132 must be connected with electric wiring 144 so it can transfer electricity away from stators 70 and to transformer 106.

In FIG. 3 flywheels (stator 70) can start and supported by assembly 7A or 7B or both.

In FIGS. 1 and 3, assembly 7A has wheel or gear 90, which is supported horizontal by support 94. Wheel or gear 90 on assembly 7A and flywheels drive wheel or gear 84 in assembly 3A or 3B is connected by belt or chain 86. Electric motor 92 has wheel or gear 120 attach, which is connoted to wheel or gear 90 so kinetic energy of motor 92 can be transfer to flywheels (magnet rotors 72 or stators 70) so it can be start and support whole system (assembly 3A or assembly 3B). Electric motor 92 is connected with transformer 106 or any electric outlet using electric cable 108.

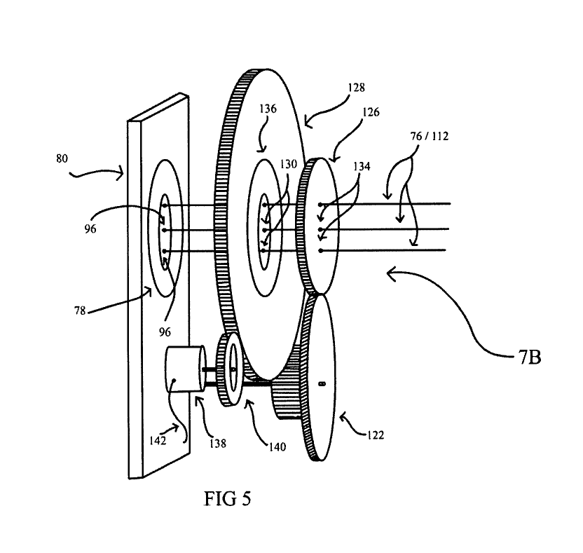

In FIG. 5 thru 7, assembly 7B has support 80 and baring 78 is same as assembly 3A and 3B has. Wheel 128 has bearing 136 in canter. Bearing 136 is connected to support 80 by rod 76 for flywheel (magnet rotors 72) assembly 3A or by rod 112 for flywheel (stator 70) assembly 3B. Rod 76 or 112 must me secured to baring 78 by using bolt 96 or 114, at baring 136 by using bolt 130 and at flywheels drive wheel or gear 126 using bolts 134. Electric motor 138 has wheel or gear 140 attach, which is connoted to wheel 128, which is connoted to wheels or gear 122, wheel or gear 122 is combination of small wheel or gear and large wheel or gear jointed to gather in center, where small wheel or gear of wheel or gear 122 connected with wheel or gear 128 and large wheel or gear of wheel or gear 122 is connoted flywheel driving wheel 128 to so kinetic energy of motor 138 can be transfer to flywheels (magnet rotors 72 or stators 70) so it can be start and support whole system (assembly 3A or assembly 3B). Electric motor 138 is connected with transformer 106 or any electric outlet using electric cable 142.

Electric cable 104 is connected to transformer 106 so it can transfer electricity where it needed.

What is claimed is:

1. A flywheels (magnet rotors) operated on concept of flywheel to generate electricity, the system comprising: a flywheels (magnet rotors) assembly comprising at last one pair of magnet rotors and at last one stators between pair of magnet rotors, where flywheels (magnet rotors) is supported by supports with low friction bearing in vertical orientation on a horizontal axle for smooth rotations; where flywheels (magnet rotors) is connected in center by at lest one rod and secured in it's place, then rod has at last one flywheel driving wheel, gear or any suitable mean, and rod is connected into bearing in each support for smooth rotation; where stator is secured to support or any where by any means, where stator can stay in place between flywheels (magnet rotors) and doesn't interferer rotation of flywheels (magnet rotors).

2. A flywheel (stator) operated on concept of flywheel to generate electricity, the system comprising: a flywheel (stator) assembly comprising at last one pair of magnet rotors and at last one stator between pair of magnet rotors, where flywheel (stator) is supported by supports with low friction bearing in vertical orientation on a horizontal axle for smooth rotations; where flywheel (stator) is connected in center by at lest on rod and secured in it's place, then rod has at last one flywheel driving wheel, gear or any suitable mean, and rod is connected into bearing in each support for smooth rotation; where magnet rotors is secured to support or any where and by any means, where magnet rotors can stay in place of two side's of flywheel (stator) and not interferer rotation of flywheels (stator).

3. A flywheels (magnet rotors) with external start and support wheel or gear, the system comprising: At last one wheel or gear supported by support and power by at last one electric motor to provide kinetic energy to the wheel or gear, then wheel or gear is connoted thru belt, pulley, chain or any suitable mean where it can transfer kinetic energy to flywheel (magnet rotors) or flywheel driving wheel or gear in claim 1.

4. A flywheels (stator) with external start and support wheel or gear, the system comprising: At last one wheel or gear supported by support and power by at last one electric motor to provide kinetic energy to the wheel or gear, then wheel or gear is connoted thru belt, pulley, chain or any suitable mean where it can transfer kinetic energy to flywheel (stator) or flywheel driving wheel or gear in claim 2.

5. A flywheels (magnet rotors) with internal start and support wheel or gear, the system comprising: at last one wheel or gear with bearing in center, powered by at last one electric motor to provide kinetic energy, and connoted to rod in center which connoted to flywheels (magnet rotors), flywheel driving wheel and into bearings on supports, the wheel or gear with bearing in center is connoted to wheel or gear system which has small and large wheel or gear jointed in center system, where small wheel or gear is connoted to wheel or gear with bearing in center and large wheel or gear is connoted to flywheel driving wheel or gear in claim 1.

6. A flywheels (stator) with internal start and support wheel or gear, the system comprising: at last one wheel or gear with bearing in center, powered by at last one electric motor to provide kinetic energy, and connoted to rod in center which connote flywheels (stator), flywheel driving wheel or gear and into bearings on supports, the wheel or gear with bearing in center is connoted to wheel or gear system which has small and large wheel or gear jointed in center, where small wheel or gear is connoted to wheel or gear whit bearing in center and large wheel or gear is connoted to flywheel driving wheel or gear in claim 2.
